(19) United States
(12) Patent Application Publication
(10) Pub. No.: US 2025/0201817 A1
(43) Pub. Date: Jun. 19, 2025

(54) Layers for Inhibiting Metal Dendrite Growth in Electrochemical Cells, and Electrochemical Cells Made Therewith

(71) Applicant: SES Holdings Pte. Ltd., Singapore (SG)

(72) Inventors: Yujia Liang, Melrose, MA (US); Yongkyu Son, Bedford, MA (US); Robert K. Kneeland, Tewksbury, MA (US)

(21) Appl. No.: 18/836,249

(22) PCT Filed: Feb. 6, 2023
(86) PCT No.: PCT/IB2023/051054

§ 371 Date: Aug. 6, 2024

Related U.S. Application Data
(60) Provisional application No. 63/306,778, filed on Feb. 4, 2022.

(51) Int. Cl. H01M 4/36; H01M 4/02; H01M 4/1395; H01M 4/38; H01M 4/62; H01M 10/0525

(52) U.S. Cl. CPC H01M 4/366; H01M 4/1395; H01M 4/382; H01M 4/628; H01M 2004/027; H01M 10/0525

(57) ABSTRACT

Anode-protective layer for inhibiting growth of dendrites from an anode. In some embodiments, an anode-protective layer of this disclosure includes a coating comprising a polymer system, one or more salts dispersed within the polymer system, and ceramic oxide particles dispersed within the polymer system. In some embodiments, the polymer system includes two or more polymers, with one polymer containing fluorine and at least one other polymer containing nitrogen. In some embodiments, the coating is applied to a porous material, such as a porous separator. In some embodiments, the anode comprises at least one active metal, such as lithium, and the salt(s) comprise the active metal. Electrochemical cells and secondary batteries that include an anode-protective layer are also disclosed.

### RELATED APPLICATION DATA

This application claims the benefit of priority of U.S. Provisional Patent Application Ser. No. 63/306,778, filed Feb. 4, 2022, and titled “LAYERS FOR INHIBITING METAL DENDRITE GROWTH IN ELECTROCHEMICAL CELLS, AND ELECTROCHEMICAL CELLS MADE THEREWITH”, which is incorporated by reference herein in its entirety.

### FIELD OF THE DISCLOSURE

The present disclosure generally relates to the field of metal-electrode electrochemical cells. In particular, the present disclosure is directed to layers for inhibiting metal dendrite growth in electrochemical cells, and electrochemical cells made therewith.

### BACKGROUND

Lithium metal batteries (LMBs) have significantly higher gravimetric and volumetric energy densities relative to conventional lithium-ion batteries (LIBs). However, the safety of LMBs is a major bottleneck for promoting the practical application of LMBs. The origins of the safety issue of LMBs are the high reactivity of lithium metal and the growth of lithium dendrites. Lithium dendrites can easily penetrate the commonly used polypropylene (PP) separators and polyethylene (PE) separators, resulting in internal electrical shorting between the anode and cathode. Additionally, “dead” lithium is formed on the surface of a lithium-metal anode during cycling. The dead lithium is unable participate in the charge/discharge. Thus, fast capacity fading is expected accompanied with the dead lithium.

Solid electrolyte interphase (SEI) engineering was discovered as an effective method to protect the lithium-metal surface. In SEI engineering, additives that have high reactivity with lithium metal are added to the liquid electrolyte. Additives, lithium salts, and solvents in electrolyte react with the lithium metal to generate SEI. Through the selection of additives, a robust SEI layer can be generated on the surface of the lithium metal. The SEI layer so formed suppresses growth of lithium dendrites and enhances the cycle life of LMBs. The SEI layer thickness is typically in range of 10 nm to 100 nm due to self-limiting growth as equilibrium within the diffusion barrier is established. The mechanical strength of the SEI layer is restricted as a result of its relative thinness. The SEI layers, less than 100 nm in thickness, afford relatively little protection from dendrite penetration or dead lithium formation.

An emerging concept to improve the mechanical robustness of lithium-metal anodes is to use solid-state electrolytes (SSEs). SSEs may be, for example, ceramic wafers, glassy pellets, polymer films, or polymeric composite membranes, and they replace existing PP and PE separators in LMB cell design. The increased mechanical strength of SSEs blocks the penetration of lithium dendrites through them. SSEs, however, suffer from one or more disadvantages of poor processability, narrow electrochemical window, low ionic conductivity, and/or inferior rate capability. The thickness of SSEs is normally in the range of >50 μm. The introduction of SSEs inevitably reduces both the gravitational and volumetric energy densities of LMBs, which are the most critical specifications of LMBs among all the existing stored energy approaches. In addition, lithium-ion conduction is solely dependent on the ionic conductivity of the SSEs. The theoretical ionic conductivity of inorganic SSEs is ˜10⁻⁴ S/cm. The ionic conductivity of polymeric and composite SSEs is ˜10⁻⁵ S/cm. To make matters worse, SSEs can decompose into compounds such as LiF, Li₂O, and Li₂CO₃ when contacting lithium metal. This further increases the impedance, or internal resistance, of a cell for lithium-ion migration between electrodes. The low ionic conductivities of SSEs make them impracticable to be used in applications that require fast charging. Low ionic conductivity also causes uneven distribution of lithium ions during plating. This uneven distribution is exaggerated by SSEs having nonuniform thickness, which is unavoidable during manufacturing. Thinner regions of SSEs are more conductive, allowing more lithium ions to reach the lithium metal than at thicker regions of the SSEs. This accelerates the growth of lithium dendrites adjacent to the thinner regions, which results in early termination of battery life.

### SUMMARY

In one implementation, the present disclosure is directed to an electrochemical cell, which includes an anode comprising an active metal that is prone to dendrite growth during charging of the electrochemical cell; an anode-protective layer disposed immediately adjacent to the anode and provided to inhibit growth of dendrites from the anode, the anode-protective layer comprising a coating that includes: a polymer system comprising two or more polymers, wherein at least one first polymer of the polymers contains fluorine and at least one second polymer of the polymers contains nitrogen; one or more active-metal salts dispersed within the polymer system; and ceramic oxide particles dispersed within the polymer system.

In another implementation, the present disclosure is directed to a protective layer for protecting lithium metal within an electrochemical cell. The protective layer includes a coating that includes: a polymer system comprising two or more polymers, wherein at least one first polymer of the polymers contains fluorine and at least one second polymer of the polymers contains nitrogen; one or more lithium salts dispersed within the polymer system; and ceramic oxide particles dispersed within the polymer system.

In yet another implementation, the present disclosure is directed to a method of making a protective layer for protecting lithium metal within an electrochemical cell. The method includes providing a first polymer solution comprising a first polymer dissolved in a first solvent; providing a second polymer solution comprising a second polymer dissolved in a second solvent; adding ceramic-oxide particles into the first polymer solution so as to create a suspension; adding at least one lithium salt into the suspension to form a mixture; and combining the second polymer solution and the mixture with one another to create a slurry that is a precursor to the protective layer.

In another implementation, the present disclosure is directed to a method of protecting a lithium-metal anode. The method includes providing a protective layer comprising a coating that includes: a polymer system comprising two or more polymers, wherein at least one first polymer of the polymers contains fluorine and at least one second polymer of the polymers contains nitrogen; one or more lithium salts dispersed within the polymer system; and ceramic oxide particles dispersed within the polymer system; and deploying the coating so as to contact the lithium-metal anode.

### BRIEF DESCRIPTION OF THE DRAWINGS

For the purpose of illustration, the drawings show aspects of one or more example embodiments. However, it should be understood that the present disclosure is not limited to the precise arrangements and instrumentalities shown in the drawings, wherein:

FIG. 1 is cross-sectional view of a portion of an example protective layer made in accordance with the present disclosure;

FIG. 2 is a graph of viscosity versus shear rate for slurries having a composition of the CPS048 sample identified in Table 1;

FIG. 3 is a graph of shear stress versus shear rate of the slurries having the composition of the CPS048 sample identified in Table 1;

FIG. 4 is a cross-sectional view of a protective layer coated onto a lithium-metal layer, illustrating a working mechanism of the protection provided by the protective layer;

FIG. 5 is a graph of Fourier transform infrared spectroscopy (FTIR) intensity versus wavenumber of the CPS052 sample identified in Table 1 during a drying process;

FIG. 6 is a graph of FTIR intensity versus wavenumber for all of the samples identified in Table 1 after each sample was dried at 60° C. in vacuum for 2 hours;

FIG. 7 is a graph of thickness for a pristine conventional ceramic-filled-polyethylene-separator (CFPES) substrate and the CFPES substrate coated with a protective layer of the CPS048 sample identified in Table 1;

FIG. 8 is a graph of stress versus strain of the CFPES substrate and the CFPES substrate+protective layer of FIG. 7;

FIG. 9 is a graph showing results of air permeability tests of the CFPES substrate and the CFPES substrate+protective layer of FIGS. 7 and 8;

FIG. 10 is graph of change in air permeability test results for the CFPES substrate+protective layer of FIGS. 7-9 at differing temperatures;

FIG. 11 is a graph of Z″ versus Z′ showing impedance results of three as-assembled lithium-metal cells having protective layers composed of the CPS048 composition of Table 1 and of differing thicknesses and the same three lithium-metal cells after being stripped/plated 5% of the lithium for 3 cycles;

FIG. 12 is a graph of electrical current versus time for the three as-assembled lithium-metal cells of FIG. 11 and the same three lithium-metal cells after being stripped/plated 5% of the lithium for 3 cycles;

FIG. 13 is a cross-sectional view of internal configuration of the lithium-metal cells tested in connection with the graphs of FIGS. 11 and 12;

FIG. 14 is a graph of capacity retention versus cycle number for lithium-metal batteries (LMBs) cycled at 1/3C within a voltage range of 2.7 V to 4.3 V, for an unprotected CFPES substrate and CFPES substrates having protective layers of differing ones of the compositions listed in Table 1;

FIG. 15 is a graph of coulombic efficiency versus cycle number for LMBs cycled at 1/3C within a voltage range of 2.7 V to 4.3 V, for an unprotected CFPES substrate and CFPES substrates having protective layers of differing ones of the compositions listed in Table 1;

FIG. 16 is a graph of capacity retention versus cycle number for lithium-metal LMBs cycled at 1/3C within a voltage range of 2.7 V to 4.3 V, for an unprotected CFPES substrate and CFPES substrates having protective layers of differing ones of the compositions listed in Table 1 laminated onto lithium metal;

FIG. 17 is a graph of coulombic efficiency versus cycle number for LMBs cycled at 1/3C within a voltage range of 2.7 V to 4.3 V, for an unprotected CFPES substrate and CFPES substrates having protective layers of differing ones of the compositions listed in Table 1 laminated onto lithium metal; and

FIG. 18 is a high-level schematic diagram illustrating an electrochemical device made in accordance with principles of the present disclosure.

### DETAILED DESCRIPTION

Aspects of this disclosure are directed to innovations to protect the surfaces of lithium metal using protective layers and in processes to make the protective layers. In this context, the term “protective” and like terms include suppressing the growth of metal dendrites (e.g., lithium dendrites) and minimizing the formation of dead metal (e.g., dead lithium). In some reports/publications, such a coating layer may be called an “artificial SEI layer.” Aspects of this disclosure provide protective layers having higher mechanical strength compared to conventional free-standing protective coating layers composed of polymer or polymeric composite membranes. The enhanced mechanical strength of a novel protective layer of the present disclosure can allow the protective layer to physically block the penetration of metal dendrites therethrough. Relevant metals other than lithium may include sodium or other alkaline earth metal and alloys of lithium, sodium, and/or other alkaline earth metal. It is noted that lithium is used in the examples herein without limiting the scope of this disclosure thereto.

In some embodiments, thin protective layers disclosed herein is less than 20 μm in thickness. Compared to the thickness of SSEs, which is typically >50 μm, the addition of a protective layer disclosed herein largely retains the high gravimetric and volumetric energy densities of lithium-metal batteries (LMBs). Also disclosed herein are chemical compositions of protective layers that can chemically convert lithium dendrites into LiF, Li₃N, and Li₂O, which are desirable compounds in SEI engineering for forming robust SEI layers. In a third aspect, this disclosure describes processes to make the protective layer, as well as a lamination process to facilitate the mass production of electrochemical cells, such as batteries. A further merit of some embodiments of the preset disclosure is reducing the addition of liquid electrolyte without deteriorating the ionic conductivity thereby further improving the gravimetric energy density of LMBs.

Before proceeding with more-detailed descriptions, it is noted that throughout the present disclosure, the term “about”, when used with a corresponding numeric value, refers to ±20% of the numeric value, typically ±10% of the numeric value, often ±5% of the numeric value, and more often ±2% of the numeric value. In some embodiments, the term “about” means the numeric value itself.

A protective layer of the present disclosure includes a coating formed of a composite polymeric substance, which is abbreviated as “CPS” in this disclosure. In some embodiments, a CPS comprises a blend of two or more polymers plus one or more lithium salts plus particles of one or more types of ceramic oxides. In some embodiments, the CPS may alternatively consist essentially of these components, while in other embodiments the CPS may alternatively consist only of these components. In a particular example, but not limiting, embodiment, the CPS includes polyacrylonitrile (PAN) and poly(vinylidene fluoride-co-hexafluoropropylene) (PVDF-HFP) as the polymer blend, lithium bis(fluorosulfonyl)imide (LiFSI) as a lithium salt, and lithium lanthanum zirconium oxide (LLZO) particles as a ceramic oxide.

Generally, in some embodiments the selection of one of the polymers may be based on providing the protective layer formed from the CPS with a high tensile strength that allows the protective layer to inhibit lithium dendrites from penetrating therethrough. In some embodiments, the selection of another of the polymers may be based on the presence of fluorine, preferably, the polymer's ability to form one or combinations of LiF, Li₂O, Li₃N, or Li—CN, which are chemically stable with lithium metal. In some embodiments, the selection of all the components in the polymer blend may comprise both benefits. In this construct, the PVDF-HFP of the PAN+PVDF-HFP blend is selected for containing fluorine that can contribute to forming LiF in an SEI layer, and the PAN is selected based on it 1) having high tensile strength and modulus of elasticity among polymers, 2) containing nitrogen that can contribute to forming Li—N, Li—C, and Li—CN to enhance chemical stability of an SEI layer when contacting the lithium metal, 3) containing a —CN grounding group that can extend the oxidation-stability window (e.g., >4.5 V vs. Li+/Li), 4) contributing to thermal stability, 5) increasing the lithium transference number, 6) inhibiting the crystallization of the PVDF-HFP in the blend so as to provide a higher lithium-ion conductivity. Examples of polymers that can be used in place of PAN include nitrogen and/or —CN containing polymers having suitable tensile strength that may include, but not be limited to, poly(styrene-co-acrylonitrile), poly(acrylonitrile-co-butadiene-co-styrene), polymethyl methacrylate (PMMA), polydimethylsiloxane (PDMS), and poly(methacrylonitrile), among others, and examples of polymers that can be used in place of PVDF-HFP include fluorine containing polymers that may include, but not be limited to, PVDF (polyvinylidene fluoride), PTFE (polytetrafluoroethylene), PCTFE (polychlorotrifluoroethylene), FEP (fluorinated ethylene-propylene), and polyethylene oxide (PEO), among others. Generally, the weight ratio of tensile strength contributing polymer(s) to robust SEI contributing polymer(s) in the CPS can be in a range from about 5% to about 95%, about 25% to about 75%, or about 35% to about 65%, among others.

One or more lithium salts are provided to the CPS to impart a desirable level of lithium-ion conductivity within the CPS and the resulting protective layer made therewith. While LiFSI is preferred in some embodiments, other lithium salts that can be included, either alone or in any suitable combination with one another and/or with LiFSI include, but are not limited to, LiClO₄, lithium bis(trifluoromethanesulfonyl)imide (LiTFSI), and LiPF₆, among others. Generally, salts having higher lithium transference numbers are preferred in some embodiments. In such cases, LiFSI would be preferred out of the salts listed above. In some embodiments, the lithium transference may be about 0.02 or greater, about 0.45 or greater, or 0.6 or greater, among other values. In some embodiments the weight ratio of the salt(s) included in a CPS to the total amount of the polymers in the CPS may range from about 0.001 to about 1, about 0.008 to about 1, about 0.0375 to about 1, or about 0.04 to about 0.4 among other amounts.

The particles of one or more ceramic oxides may be provided for any of one or more reasons, including increasing the lithium-ion conductivity of the CPS and the resulting protective layer (e.g., using a lithium-containing ceramic oxide (such as LLZO)) and inhibiting crystallization of the one or more polymers selected for providing the final CPS coating with a high tensile strength. Generally, the particle size is not critical. In examples disclosed herein, 550 nm LLZO particles were used. However, any LLZO particles, or other ceramic-oxide particles in general, with a size from about 10 nm to about 10 μm, less than about 1000 nm, less than about 5 μm, or less than about 10 μm can be used. In some embodiments, the LLZO can include one or more dopant elements selected from, for example, Bi, Al, Ta, and Ga, among others. Ideally, LLZO particles shall have a cubic phase due to its highest Li-ion conductivity among all crystal phases of LLZO. In some embodiments, LLZO having a tetragonal phase can also work. In other embodiments, LLZO particles can be replaced by or supplemented with other ceramic oxide particles, for example, SiO₂ or Al₂O₃, among others. In some embodiments, the weight ratio of particles included in a CPS coating to the total amount of the polymers in the CPS coating may range from about 0.01 to about 2, about 0.13 to about 1, or about 0.25 to about 2, among other amounts.

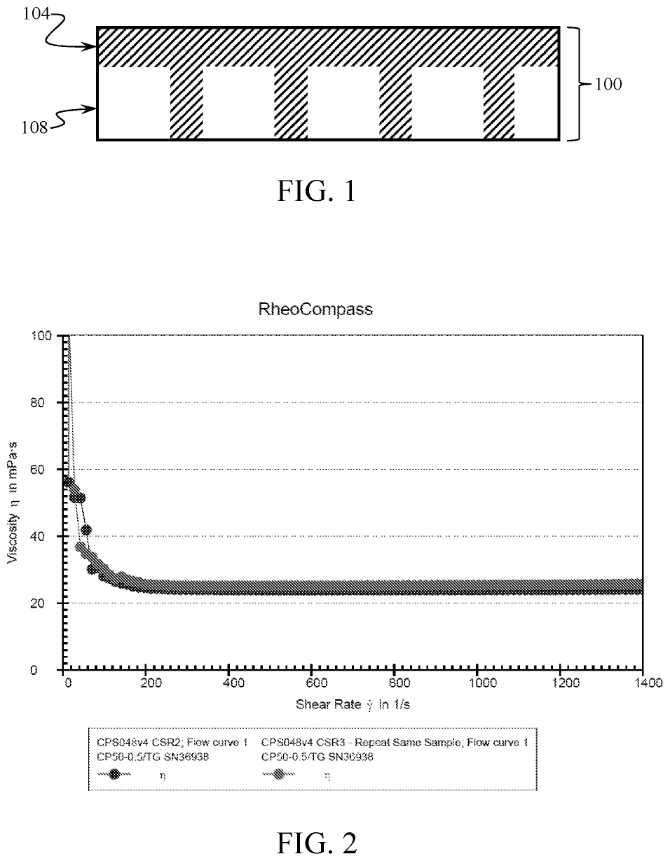

In some embodiments a precursor slurry to the CPS is coated onto a substrate to form a protective layer 100, which in such embodiments comprises both the CPS coating 104 and the substrate 108, as depicted in FIG. 1. Using a suitable substrate 108 as a carrier of the CPS coating 104 can assist with cell construction, as the substrate can make the protective layer 100 easy to handle. In addition, keeping the CPS coating 104 initially separate from the lithium metal (not shown) it is designed to protect avoids challenges that can arise from applying the CPS coating directly to the surface of the lithium metal. The substrate 108 is preferably porous and may be any suitable substrate, such as a conventional separator (e.g., polyethylene (PE)-based separator or a polypropylene (PP)-based separator, coated or uncoated), among other porous sheets, including, but not limited to, glass fibers and sponge-like foam.

In some embodiments, a porous version of the substrate 108 may have a porosity from about 45% or greater, about 50% to about 80%, about 6% to about 90%, or about 70% to about 90%, among other ranges. In such embodiments, the substrate 108 may have an average effective pore size of about 5 μm or less, about 2 μm or less, or about 1 μm or less, among other ranges. Examples below utilize a conventional ceramic-filled-PE-separator (referred to below as “CFPES”), which has a porosity of about 70% and an average effective pore size of about 1 μm, is used as the substrate 108. In this application, the substrate 108 may or may not function as a conventional separator in addition to supporting the CPS coating 104. In some embodiments, the substrate 108 has a thickness from about 20 μm or less, about 10 μm or less, or about 5 μm or less, amount others. In some embodiments wherein gravitational and volumetric densities need to be as high as possible, the porous substrate should be as thin as possible while providing the desired strength properties and/or the desired handling properties for aiding cell manufacturing.

In some embodiments, the CPS coating 104 on a porous type of the substrate 108 can itself be porous, depending on, for example, its viscosity when applied as a slurry (see below), its thickness after drying (also see below), the volume of solvent(s) in the slurry removed during drying, and the average effective pore size of the substrate. Depending on the porosity of the CPS coating 104 in the finished protective layer 100 and the use of a liquid electrolyte (not shown), any pores within the CPS coating, in conjunction with the pores within the substrate 108, can permit direct flow of lithium ions (not shown) within the liquid electrolyte through the protective layer 100 generally. This ionic flow dominates the lithium-ion conductivity of the CPS coating 104, while the ionic conductivity of the CPS material itself still supplement the migration of the lithium ions. In some embodiments, the equivalent pore size of the CPS coating 104 may be about 1 μm or less, about 320 nm or less, or about 0.25 nm or less, among other values. That said, in some embodiments, the pores in the CPS coating 104 may be too small to permit lithium-ion flow or may be completely absent, such that an electrochemical cell made using such an embodiment of the protective layer 100 must rely completely on the lithium-ion conductivity of the CPS coating itself. In some embodiments, the thickness of the CPS coating 104 when applied to the substrate 108 may be in a range of about 30 μm or less, about 10 μm or less, about 5 μm or less, or about 1 μm or less, among others. In some embodiments wherein gravimetric and volumetric densities of the electrochemical cell or battery incorporation the same need to be as high as possible, the CPS coating 104 should be as thin as possible, for example, less than about 17 μm thick, while providing the desired protection to the target lithium metal or the desired portion of protection if full protection (i.e., chemical and physical barrier) is provided by the protective layer 100, a combination of the CPS coating 104 and the substrate 108 (e.g., porous substrate), as depicted in FIG. 1.

In some embodiments, the CPS may be coated directly onto the surface of lithium metal (e.g., layer, foil, etc.) that is the target for protection by the protective layer. In this case, the protective layer consists, or consists essentially of, the CPS coating. In some embodiments in which the CPS is directly coated onto lithium metal as the protective layer, the thickness of the CPS layer/protective layer may be the same as the thickness of the CPS layer as applied to a substrate as discussed above.

In an illustrative example, a CPS slurry comprising PAN, PVDF-HFP, LiFSI, and LLZO particles is made by mixing them into a solvent consisting of dimethylformamide (DMF). The CPS slurry is then coated onto a porous substrate, for example, using a doctor blade. The CPS slurry coating is then dried, for example, in a vacuum oven at 60° C. to yield the protective layer composed of the dried CPS coating adhered to the porous substrate. It is noted that a vacuum is not obligatory, nor is heating to any particular temperature, as long as the requisite amount of the solvent(s) (here, DMF) has been removed from the CPS coating before deployment in a cell for use. In cases in which a solvent used in making the CPS slurry is highly reactive with lithium metal, it is important to remove all or virtually all of that solvent during drying so that it does not consume the lithium metal. However, in some cases, a solvent used in making the CPS slurry may provide a benefit to an electrochemical cell such that it is not necessary to drive out all of that solvent during drying. Once the protective layer has been formed, it may be laminated, for example, by thermal lamination, onto the surface of the target lithium metal to be protected, for example, to facilitate the assembly process of an LMB.

It is noted that nanoparticles and micron-size particles are extremely difficult to suspend in a solution or a slurry due to their high surface area. In some scenarios, one or more salts are demanded in a CPS slurry, and this can lead to increased aggregation of the particles due to the effects of the additional salt ions. In an example process for making a CPS slurry to maximize uniformity of dispersion of the ceramic particles within the CPS slurry, each polymer is first dissolved into solvent to form respective individual polymer solutions. The desired ceramic-oxide particles may then be added into at least one of the polymer solutions to form a stable suspension without aggregation. Then, the salt(s) is/are added into this suspension to form a stable mixture. Then, the other polymer solution(s) is/are gradually added into the stable mixture to form the CPS slurry. In an example, the obtained CPS slurry may be coated onto one or more substrates and dried to become part of the protective layer, for example as noted above. As also noted above, in some embodiments the resulting protective layer may be laminated onto a lithium-metal anode by a thermal process to facilitate battery assemble process.

While DMF is used as a solvent in examples provided herein, the solvent may additionally or alternative be any other suitable solvent or solvent mixture for the selected polymer(s), including, but not limited to, N-methylpyrrolidone (NMP), dimethylacetamide (DMAc), and tetrahydrofuran (THF), among others. It is also noted that coating techniques other than doctor-blade coating may be used to apply the CPS slurry. Examples of other coating techniques include, but are not limited to, spin coating, spray coating, slot-die coating, dip coating, flexography, layer-by-layer coating, and micro-gravure coating, among others.

### Example 1

In a specific example, PVDF-HFP (average molecular weight: 268,000, PVDF to HFP weight ratio=9:1) was first dissolved into DMF to form a PVDF-HFP solution. In this example, the concentration was 3 g PVDF-HFP per 10 g DMF; however, the molecular weight of the PVDF-HFP and the relative ratio of the PVDF to the HFP are not limited to the ones used in this example. Generally, any available PVDF-HFP blend will work in this scenario. In this example, the LLZO particles were then added into the PVDF-HFP solution and followed by a mixing process. The mixing process was conducted by acoustic mixing following by planetary mixing to form a suspension. However, any other suitable mixing process(es) also work. This example utilized LLZO particles having a size of about 550 nm. Those skilled in the art will understand that commercially available LLZO typically contains one or more dopants of Bi, Al, Ta, and Ga to obtain LLZO particles of cubic phase. The presence and type(s) of dopant(s) generally do not impact desired qualities of the LLZO and any doped LLZO can be used. Although cubic phase is desired, tetragonal phase of LLZO also work in this scenario. LiFSI salt was added into the suspension to form a mixture. As noted above, in other embodiments other lithium salts, for example, LiClO₄, LiTFSI, and LiPF₆, can also or alternatively be used. Next, a PAN solution (here, 1 g PAN per 10 g DMF) was added into the mixture to form the CPS slurry. This example utilized a PAN having an average molecular weight of 150,000. However, other available PANs with different molecular weights are also applicable. In some embodiments: the weight ratios of the each components presented in the above paragraphs all work. Six illustrative, and nonlimiting, CPS compositions containing PAN, PVDF-HPF, LLZO, and LiFSI are shown in Table 1, below.

TABLE 1
Six Examples of CPS Compositions

| Sample name | PAN/PVDF-HFP | Polymer/LLZO | LiFSI/LLZO |
|---|---|---|---|
| CPS047 | 0.5 | 4 | 0.167 |
| CPS048 | 0.05 | 2 | 0.167 |
| CPS049 | 0.25 | 4 | 0.167 |
| CPS050 | 0.25 | 2 | 0.167 |
| CPS051 | 0.5 | 2 | 0.167 |
| CPS052 | 0.05 | 4 | 0.167 |

After making the CPS slurry, it was coated onto a porous substrate, in this case, a commercially available CFPES that had a porosity of 70%, as depicted in Table 2, below. In this example, a doctor blade was used to coat the CPS slurry onto the CFPES substrate. In this example, the coated samples were dried at 60° C. under vacuum. It is noted that the high temperature and vacuum conditions are not compulsory, as long the CPS slurry can be dried so as to minimize the amount of DMF residue.

TABLE 2
Porous Substrates used in Examples

| Names | Main component | Porosity (%) |
|---|---|---|
| CFPES | PE + Al₂O₃ | 70 |
| PP | PP | 45 |

In this example, a laminating step was performed to facilitate later battery-assembly processes. For the lamination, the CPS coated side of the protective layer was contacted with the lithium metal directly. Pressure and heat were applied to Li+CPS coating+CFPES substrate sandwich structure. In the experiments, the heating temperature was 80° C. and the heating time was 180 seconds. However, these particular parameters are not compulsory for the laminating process. Generally, the temperature should be below the melting point of lithium metal.

### Example 2

This example demonstrates a specific experiment to make a protective layer that includes the CPS048 sample noted in Table 1, above. The experiment proceeded as follows.
a) Mixed 6.014 g of a PVDF-HFP solution (3 g PVDF-HFP per 10 g DMF) and 22.372 g DMF by acoustic mixing (30 g acceleration for 3 min) and mixing with a planetary mixer (1600 rpm 10 min then 2200 rpm 2 min), in sequence.
b) Added 0.729 g of LLZO particles (550 nm size) and 10.385 g beads (milling medium) into the mixture of Step a). Mixed the suspension by acoustic mixing (30 g acceleration for 3 min) and mixing with a planetary mixer (1600 rpm 10 min then 2200 rpm 2 min), in sequence.
c) Added 0.122 g of LiFSI into the mixture of Step b). Mixed the slurry by acoustic mixing (30 g acceleration for 3 min) and mixing with a planetary mixer (1600 rpm 10 min then 2200 rpm 2 min) in sequence. As necessary, added DMF until the slurry had good flowability, together with mixing the slurry by acoustic mixing (30 g acceleration for 3 min) and mixing with a planetary mixer (1600 rpm 10 min then 2200 rpm 2 min), in sequence.
d) Added 0.763 g of a PAN solution (1 g PAN per 10 g DMF) into mixture of Step c). Mixed the slurry by acoustic mixing (30 g acceleration for 3 min) and mixing with a planetary mixer (1600 rpm 10 min then 2200 rpm 2 min) in sequence. As necessary, added DMF until the slurry had good flowability, together with mixing the slurry by acoustic mixing (30 g acceleration for 3 min) and mixing with a planetary mixer (1600 rpm 10 min then 2200 rpm 2 min), in sequence. The typical slurry viscosity and shear stress are presented in accompanying FIG. 2 and FIG. 3, respectively.
e) Quality check as necessary. Placed the mixture into hood for several days to observe if the separation or sedimentation occurred.
f) Cast the slurry on an CFPES substrate as the porous substrate using a doctor blade with a height of 50 μm. Dried the sample in oven under vacuum for 4 hours at 60° C. to form the protective layer.
g) Quality check as necessary. Checked for DMF residue.
h) Lamination: pressed protective layer onto lithium metal with the CPS048-coated side of the protective layer directly contacting lithium metal while being heated at 80° C. for 180 s.
   Example Working Mechanism of a CPS-Coated Protective Layer of this Disclosure

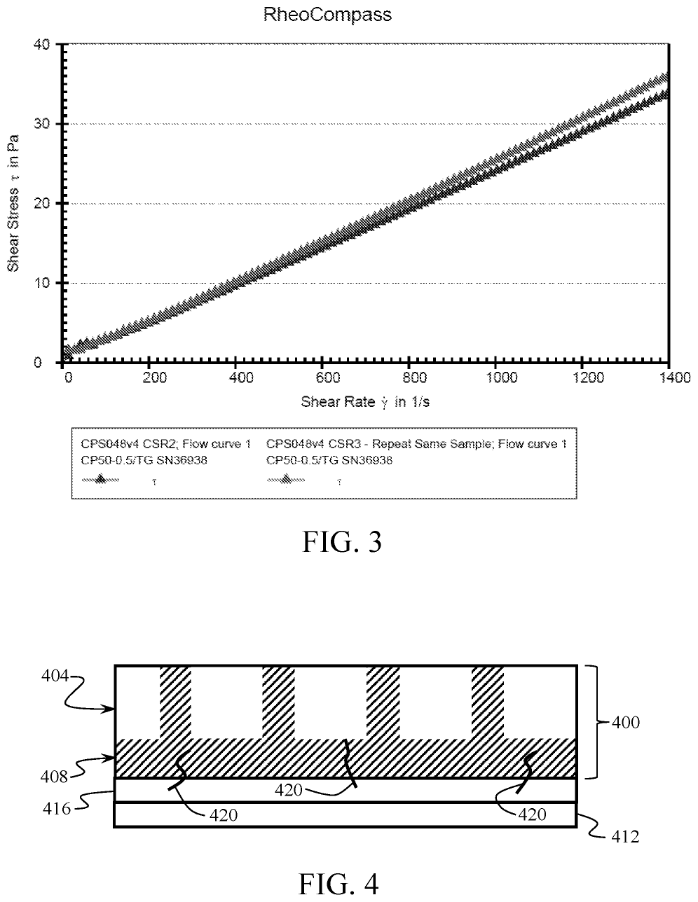

A conventional protective layer functions as sacrificial layer, buffer layer, and/or artificial SEI layer in some conventional electrochemical cells. An example working mechanism of a protective layer of the present disclosure is illustrated by FIG. 4. In FIG. 4, a protective layer 400 comprises a porous substrate 404 and an example CPS coating 408 applied to the porous substrate. As noted above, the porous substrate 404 may be a commercially available CFPES that can contribute two main benefits. First, it can provide excellent mechanical strength, at least comparable to conventional separators. Second, lithium-ion flow is not significantly deteriorated due to its high porosity.

For the compositions of the CPS coating 408 of this example, the PVDF-HFP discussed above was adopted due to its fluorine-rich property. When reacting with lithium metal, PVDF-HFP delivers a large amount of LiF, which forms a highly stable SEI layer. PAN, also discussed above, was used due to its nitrogen-rich property and excellent tensile strength. PAN decomposes into Li₃N-dominated products when contacting lithium metal. Li₃N is also a favorable SEI material for suppressing lithium dendrite growth. Moreover, the −CN ground can extend the electrochemical window to a wide range that is compatible with all existing commercialized cathodes. The co-presence of multiple polymers within a CPS coating of the present disclosure, such as the CPS coating 408, can reduce the extent of crystallization during the drying process, which increases the ionic conductivity of the CPS coating. The addition of LLZO particles to the CPS coating 408 also disturbs the crystallization of the polymer for a higher ionic conductivity. At the same time, the high ionic conductivity of the LLZO particles can also benefit lithium-ion migration. LiFSI was added to the CPS coating 408 to further enhance the ionic conductivity. As with Example 1, above: the weight ratio of PAN to PVDF-HFP may be in a range from about 0.05 to about 0.95; the weight ratio of total polymers (PAN plus PVDF-HFP) to LLZO may be in a range from about 0.5 to about 4; and the weight ratio of LiFSI to LLZO can be in the range from about 0.15 to about 0.5, without limitation.

Referring again to FIG. 4, once the protective layer 400 contacts a lithium metal 412, an SEI layer 416 will be formed. The composition of the SEI layer 416 will varies depending on the composition of the CPS coating 408. In an example, the SEI layer 416 comprises LiF, Li₃N, Li₂O, and lithium organometallic compounds. In normal cycling conditions, the SEI layer 416 is mechanically strong enough and chemically stable enough to suppress the growth of lithium dendrites 420. In worst conditions, the penetration of lithium dendrites 420 will be resisted by the protective layer 400 when the lithium dendrites 420 contact the CPS coating 408. The high reactivity of the lithium dendrites 420 with the CPS coating 408 will immediately convert the lithium dendrites into chemically stable compounds such as the LiF, Li₃N, Li₂O, and lithium organometallic compounds noted above. In other scenarios, the lithium dendrites 420 will be physically blocked by the substrate 404. Both the chemical and physical features of the protective layer 400 contribute to the enhanced suppression of the lithium dendrites 420.

### Material Properties of the Experimental CPS-Coated Protective Layers

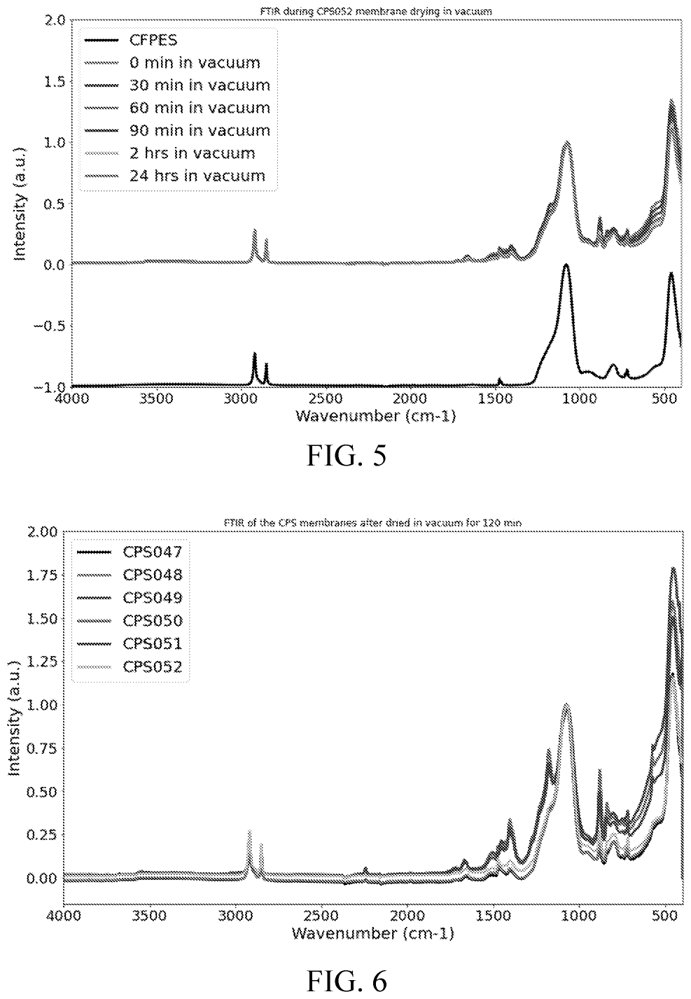

Fourier-transform infrared spectroscopy (FTIR) was applied to detect residue of DMF during the drying process. As demonstrated by FIG. 5, after 2 hours of drying in vacuum at 60° C., the DMF was undetectable in the CPS coating, as validated by the identical FTIR curve from the same sample being dried in same conditions but for 24 hours. As noted above, the heating and vacuum are not compulsory as long as the DMF (or solvent, generally) is completely extracted from the CPS coating. That said, in some scenarios trace amounts of DMF (or certain solvent(s), more generally) can improve the performance of the electrochemical cell into which the protective layer will be deployed. For example, the residue solvent may participate in the formation of a robust SEI layer. Different CPS compositions are also reflected in the FTIR curves of the CPS coatings after being dried for 2 hours at 60° C. in a vacuum, as shown in FIG. 6. The differences among the FTIR curves indicate the benignity of the film to the solvent. Considering time-efficiency and drying outcomes, the drying condition were set in this experiment to 4 hours at 60° C. in a vacuum as an exemplary illustration.

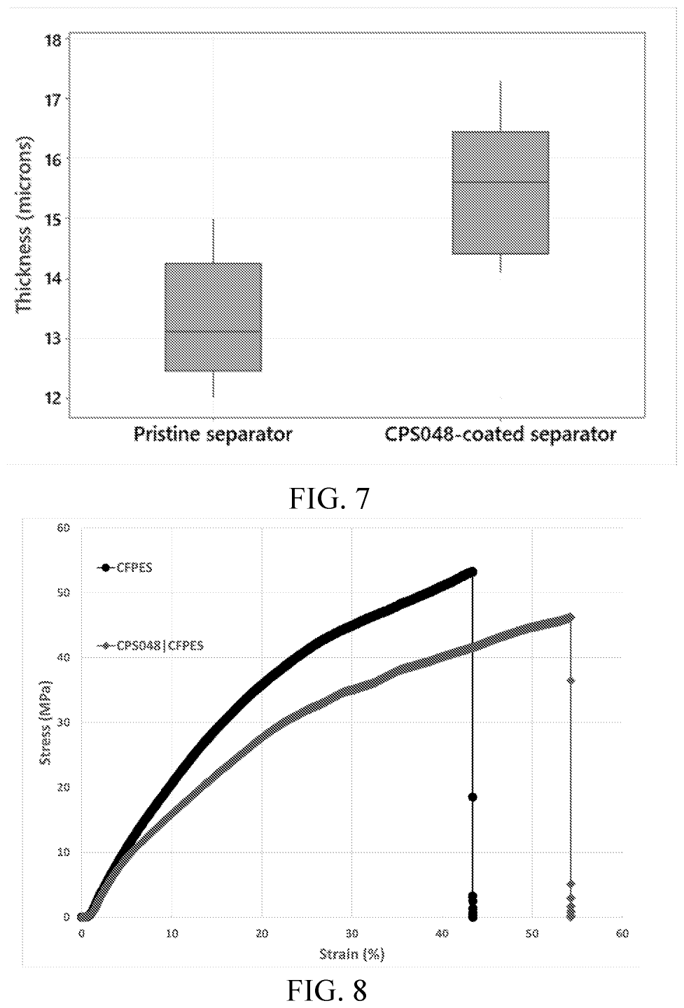

As a coating on the porous substrate, the dried CPS coating can be readily applied to lithium metal as the protective element of the protective layer. As shown in FIG. 7, the thickness of the pristine CFPES substrate had an average value of 13.2 μm. After being coated with the CPS coating to form the protective layer, the thickness increased to an average of 15.6 μm. The thin layer of the CPS coating benefits from the Newtonian properties of the CPS slurry that can be seen in FIGS. 2 and 3. The ability to deliver as thin a protective layer as possible can be critical, for example, in maintaining high energy densities of LMBs incorporating the protective layer.

The resulting protective layer, i.e., the CPS-coated CFPES substrate, displayed excellent mechanical strength that permits the protective layer to endure high stress and large elongation, as depicted in FIG. 8, properties that translate directly into making the protective layer highly resistant to dendrite penetration. The mechanical strength largely originates from the substrate, here, the CFPES substrate. Compared to free-standing polymer or polymeric composite films, protective layers produced in accordance with the present disclosure possess superior mechanical strength when compared to conventional separators. In some embodiments, it is desirable for the protective layer to have a combination of high tensile strength at relatively high strain, as this combination of material properties can provide the greatest physical resistance to dendrite growth. For example, the protective layer may have a tensile strength greater than about 10 MPa at a strain greater than about 60%, greater than about 40 MPa at a strain greater than about 50%, greater than about 60 MPa at a strainer greater than 30%, or in a range of about 10 MPa to about 80 MPa with a strain in range of about 20% to about 90%, among other ranges.

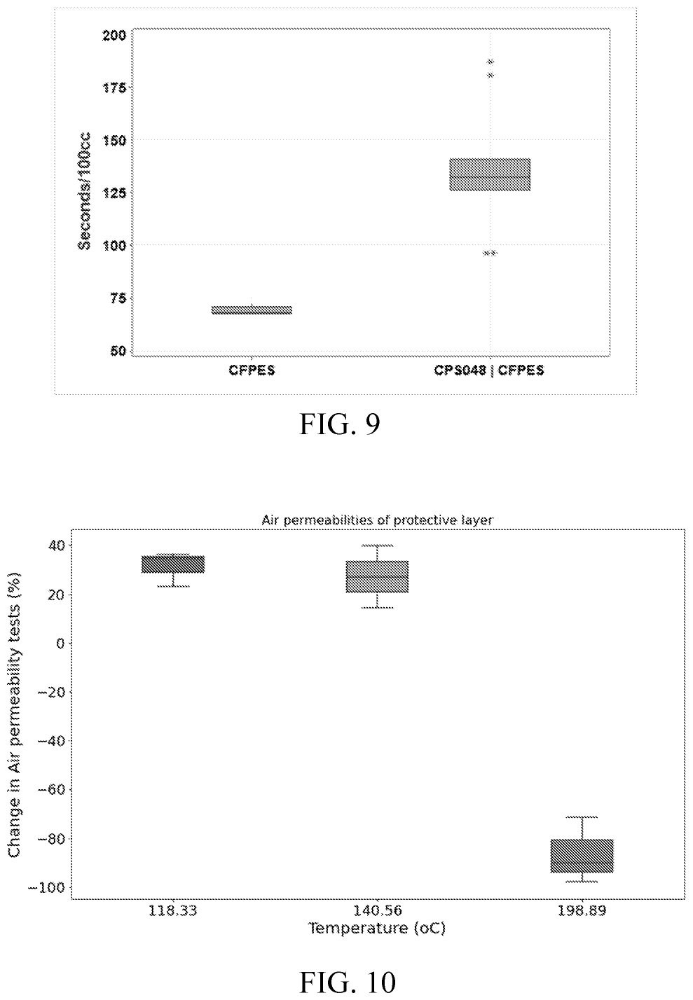

On the other hand, the Newtonian fluidic properties of the slurry, again, demonstrated by FIGS. 2 and 3, allowed the CPS coating to largely maintain the porosity of the CFPES. In air-permeability measurements, the CPS048-coated CFPES substrate (i.e., the protective layer) demonstrated an average of 130 s for 100 cc air to flow through the protective layer (FIG. 9). Although the pristine CFPES substrate has only an average time of 70 s in air-permeability testing, the CPS048-coated CFPES substrate still displayed a comparable air permeability compared to conventional separators. The high air permeability suggests that the CPS coating will not significantly retard the migration of lithium ions in a liquid electrolyte through the protective layer, such that the addition of protective layer does not necessarily introduce significant impedance to cells made therewith.

The experimental protective layer exhibited a thermal shutdown temperature between 141° C. and 199° C., as illustrated in FIG. 10. The thermal shutdown effect was caused by the polymers in the CPS coating 403 and in the PE-based substrate 405 melting and forming a substantially continuous layer to block the flow of ions in the electrolyte. The air permeability test readings dropped tremendously between 141° C. and 199° C., which means the melting of the protective layer caused its significant shrinkage and the resulting drop in change of air permeability readings from +30% to −80% in FIG. 10. After melting, the protective cannot cover the outlet channel of the air, so that the 100 cc air can pass without experiencing impedance from the protective layer. In the experiments, the air permeability of each sample was first measured at room temperature. The same sample was then heated at high temperatures for 45 min and then the air permeability was measured again. The heating temperature is not critical because the melting of sample will initiate immediately once the sample temperature reaches its melting point. The thermal shutdown temperature of conventional PE-based separator is ˜135° C. As the CFPES used as the substrate 405 is one type of conventional PE-based separator, the CPS coating 403 of the protective layer enhances the thermal shutdown temperature or at least did not deteriorate the thermal shutdown properties of the substrate. This is another benefit of a protective layer made in accordance with the present disclosure.

### Electrochemical Performance

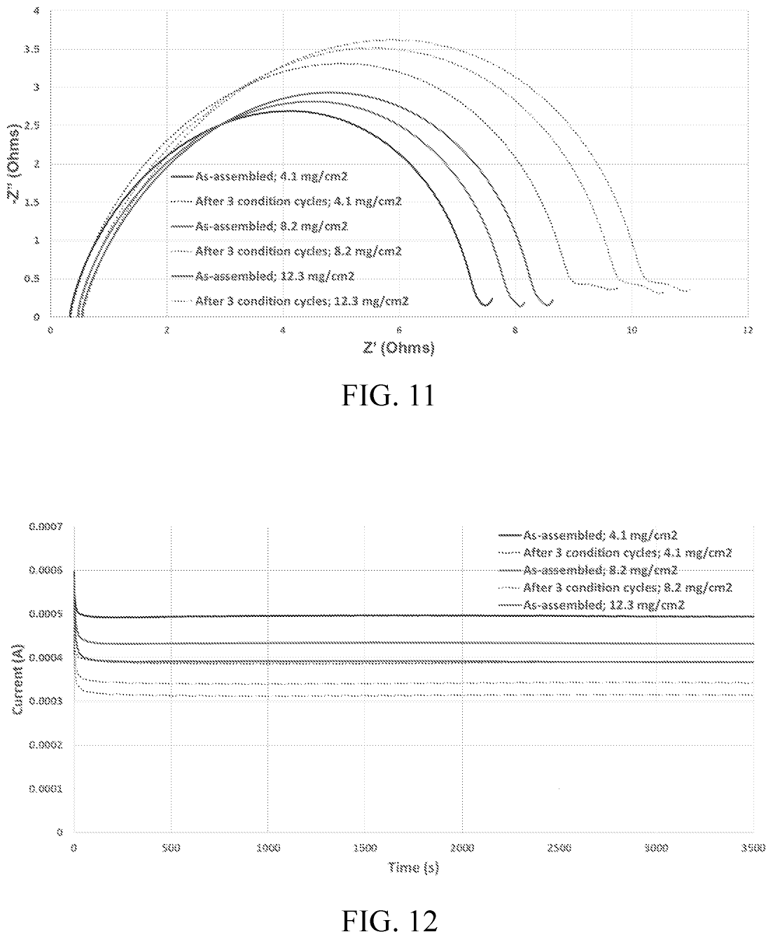

The lithium transference number of the protective layer can also be a critical specification to show that the protective layer can maintain excellent cycling performance while demanding minimal amount of liquid electrolyte. In symmetrical cells, wherein the protective layer is sandwiched by two lithium foils, different amounts of an LiFSI+LiBFOB+DEE+TFE (diethyl ether+2,2,2-trifluorethanol) electrolyte was added into the cells. It is noted that any liquid electrolyte/electrolyte combination will theoretically work in this disclosed scenarios. Practically, the wetting of liquid electrolyte on the protective coating has the same requirement(s) as the wetting of liquid electrolyte on conventional separators in the lithium-ion or lithium-metal batteries, which can be immediately recognized by people with ordinary skill. For example, a protective layer containing PVDF-HFP may work better with any liquid electrolytes or liquid electrolyte combinations using low polarity solvent. A protective layer having PEO may work better with liquid electrolytes or liquid electrolyte combinations using high polarity solvent. Two impedance tests were performed prior to and post constant-voltage measurements. As the lithium transference number measurement is highly correlated with the equilibrium conditions, the experiments were performed in two procedures under two corresponding conditions. Lithium-lithium symmetrical cells were assembled for this experiment. The first procedure was testing the cells after they were freshly made, or as-assembled. The second procedure was testing the cells after stripping/plating 5% of the total amount of lithium in the cells for 3 cycles. FIG. 11 presents the results of impedance tests prior to the constant voltage measurements and shows that the impedance generally increased after 3 condition cycles. The constant-voltage measurement results are shown in FIG. 12. 5 mV were applied during the measurements. To calculate the lithium transference number, the equation reported by Wenqiang Zhang et. Al. in “A durable and safe solid-state lithium battery with a hybrid electrolyte membrane,” Nano Energy 45 (2018) 413-419 was used. The results are listed in Table 3, below. Interestingly, the lithium transference number decreases with the increase of the amount of liquid electrolyte. The lithium transference number results show that 4.1 mg/cm² of the DEE+TFE electrolyte worked best with the experimental protective layer. This amount of liquid electrolyte was added to all the cells for the electrochemical tests. The other two liquid electrolyte amounts are conventionally used in LMBs. Thus, the utilization of the protective layer can reduce at least half of the liquid electrolyte amount, which can reduce the manufacturing cost, enhance the safety, and increase the gravimetric and volumetric energy densities of LMBs.

TABLE 3
Lithium transference number of protective layer

| | 4.1 g/cm² | | 8.2 g/cm² | | 12.3 g/cm² | |
|---|---|---|---|---|---|---|
| | | After 3 | | After 3 | | After 3 |
| | As- | condition | As- | condition | As- | condition |
| | assembled | cycles | assembled | cycles | assembled | cycles |
| Li transference # | 0.37 | 0.45 | 0.22 | 0.32 | 0.16 | 0.19 |

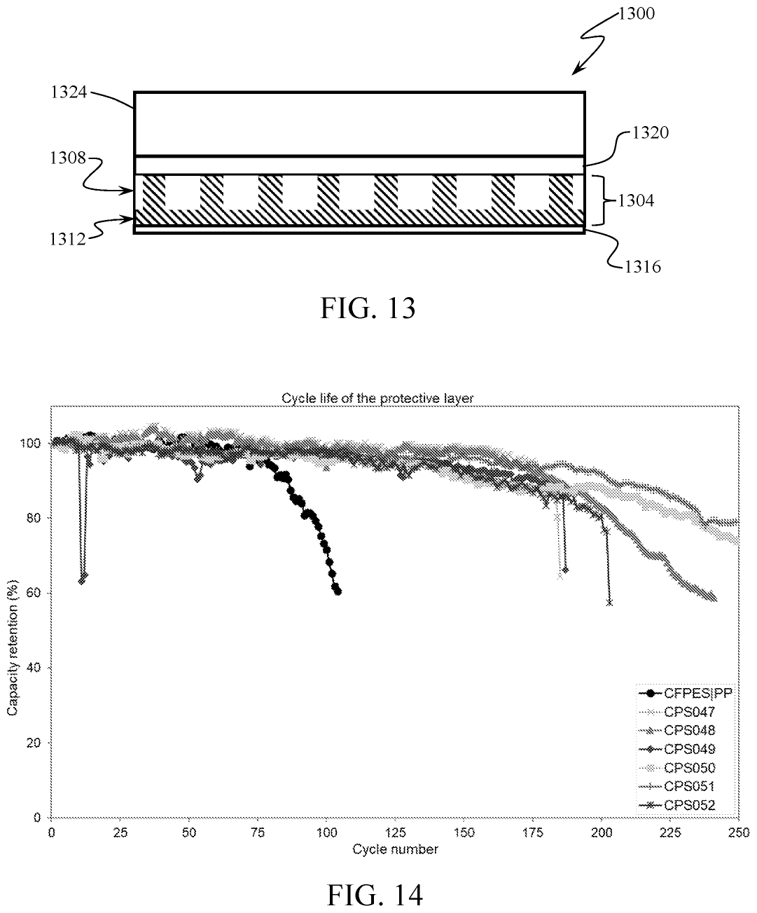

In the electrochemical tests, each cell 1300 was built based on the configuration shown in FIG. 13. A protective layer 1304, containing a CFPES substrate 1308 and a CPS coating 1312, was placed directly on the surface of lithium metal 1316, with the CPS-coating side contacted the lithium metal. A PP separator 1320 was placed between the protective layer 1304 and a cathode 1324 of the cell 1300. The PP separator 1320 had a porosity of 45% (see Table 2, above). A liquid electrolyte (not shown) was provided to the cell 1300 in an amount of 1.2 g/Ah, and the liquid electrolyte used was the DEE+TFE electrolyte noted above.

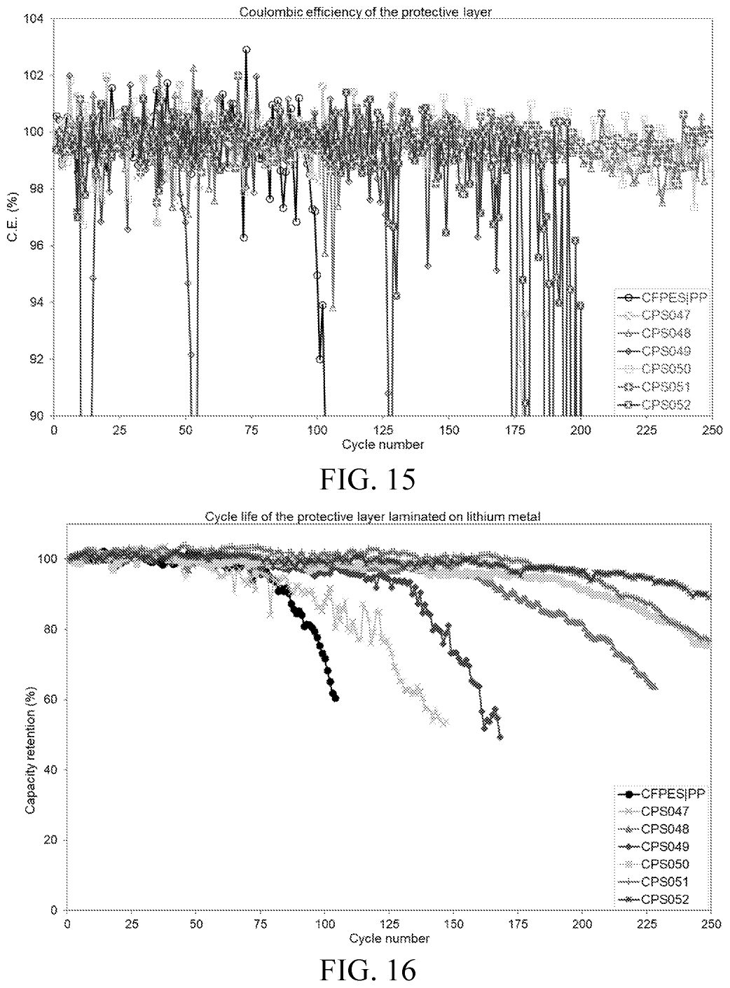

As depicted in FIG. 14, the black-circle curve is the baseline data using a pristine CFPES substrate without a CPS coating. The baseline condition exhibited a cycle life of 100 cycles with a lean amount of the electrolyte. When the protective layer 1304 of FIG. 13 was present, the cycle life was improved to over 175 cycles for all CPS-coating compositions presented in Table 1, above. For compositions CPS048, CPS050, and CPS051, the capacity retentions could remain above 80% for at least 200 cycles. As shown in FIG. 15, the Coulombic efficiencies were significantly improved when using the protective layer 1304 as compared to using only the pristine CFPES separator.

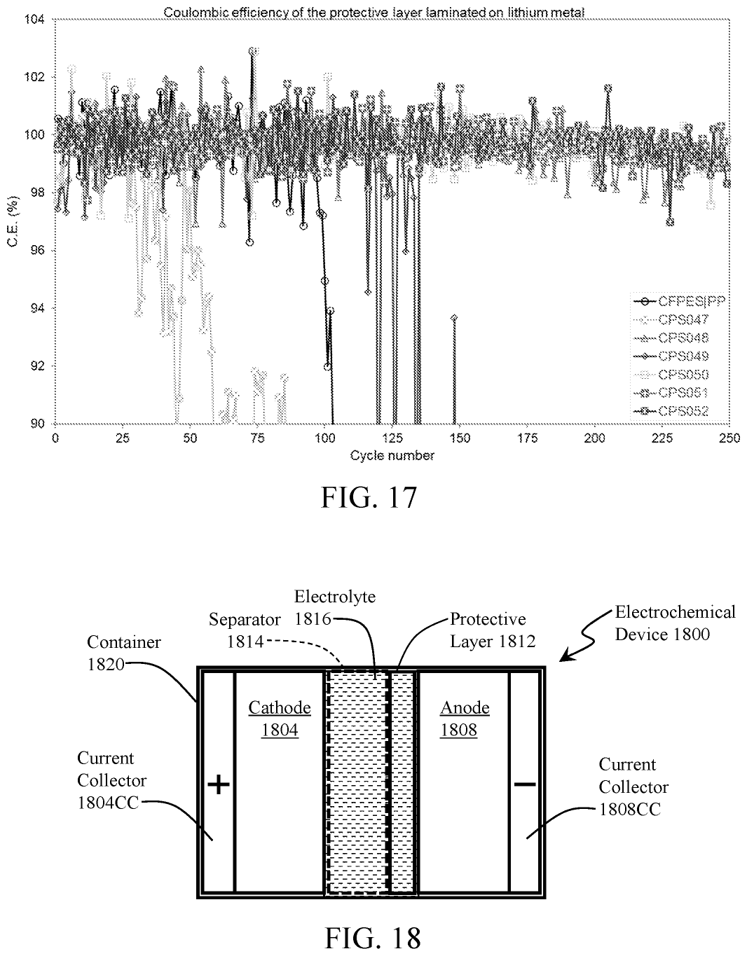

To facilitate cell-building in mass production, the protective layer 1304 was laminated onto the lithium metal 1316. In that case, each protective layer 1304 was first laminated onto a corresponding lithium metal 1316. Then, the PP separator 1320 and the cathode 1324 were stacked with the protective layer+lithium metal laminate. The cycle lives of the experimental cells 1300 so constructed are presented in FIG. 16. The baseline data was still the pristine CFPES in place of the protective layer 1304 of FIG. 13. However, as the CFPES separator is hard to laminate onto the lithium metal 1316, the baseline is the same as the ones in the FIGS. 14 and 15. As illustrated in FIG. 16, compositions CPS048, CPS050, CPS051, and CPS052 for the protective layer 1304 all displayed capacity retentions over 80% after 200 cycles, which are twice of the cycle life of the baseline. The Coulombic efficiency of baseline sample dropped dramatically and early compared to the majority of the protection-layer samples, as depicted in FIG. 17.

The composition of this CPS-coating example is unique, as it is the first one to use the combination of PVDF-HFP, PAN, LLZO, LiFSI, and a substrate. Each component of the CPS coating has its distinct function in the design as follows:
a) PVDF-HFP and PAN are used to produce robust SEI layer and extend the electrochemical window to match the lithium metal and existing cathodes;
b) PAN also contributes to the enhanced tensile strength of the CPS coating as well as the protective layer;
b) two polymers are used to reduce the crystallinity of the CPS coating and increase its ionic conductivity;
c) LLZO aims to reduce the crystallinity of the CPS coating and increase its ionic conductivity;
d) LiFSI is for improving the ionic conductivity of the CPS coating;
e) the substrate, e.g., CFPES substrate, enhances the mechanical strength of the CPS coating, maintains high porosity of the resulting protective layer, and provides a good thermal shutdown property; and
f) the slurry composition falls into Newtonian region, which can deliver a thin coating layer that helps achieve high gravimetric energy densities and permeability of the finished protective layer.

It is noted that the foregoing functions need not be performed by the specific materials used in the experiments disclosed herein. Rather, these functions can be generalized to cover other materials that can provide the same function(s) so as to allow such other materials to be substituted for or used in combination with the specific materials used for these experiments.

It is also noted that, in addition to providing protection in LMBs and cells for LMBs, protective layers of the present disclosure can also be used in Li—O₂, Li—CO₂, and Li-air cells and batteries, and even in lithium-ion batteries (LIBs) and cells for LIBs. The design principles for the CPS and the disclosed composition herein can be applied as solid-state electrolytes (SSEs) as well. The protective layer disclosed herein can also be applied in the sodium-ion batteries, potassium-ion batteries, and multivalent-ion (e.g., Ca²⁺, Al³⁺, and Mg²⁺) batteries by changing the salts to the corresponding metal salts in the CPS. For example, LiFSI shall be replaced by sodium (I) Bis(trifluoromethanesulfonyl)imide (NaTFSI) for sodium-ion batteries. The compositions, protective layers, and lamination processes can also be applicable to solar cells, among others.

### Example Electrochemical Cell:

FIG. 18 illustrates, in a highly-simplistic form, an example electrochemical device 1800 that can be made in accordance with aspects of the present disclosure. Those skilled in the art will readily appreciate that the example electrochemical device 1800 can be, for example, a battery cell, such as a secondary battery cell, or a supercapacitor, among other things. In addition, those skilled in the art will readily understand that FIG. 18 illustrates only some of the basic functional components of an electrochemical device and that a real-world instantiation of the electrochemical device, such as a secondary battery cell or a supercapacitor, will typically be embodied using either a stacked construction or a wound construction composed of or forming one or more of the various layers depicted in FIG. 18. Further, those skilled in the art will understand that the electrochemical device 1800 may include other components, such as electrical leads, electrical terminals, seal(s), thermal shutdown layer(s), electrical circuitry, gas-gettering feature(s), and/or vent(s), and sensors, among other things, that, for ease of illustration, are not shown in FIG. 18.

In this example, the electrochemical device 1800 of FIG. 18 includes a spaced-apart cathode 1804 and anode 1808 and a pair of corresponding respective current collectors 1804CC and 1808CC. A protective layer 1812 of the present disclosure is located between the cathode 1804 and the anode 1808 and confronts the anode. The protective layer 1812 may be any protective layer described herein, such as a protective layer comprising a porous or nonporous substrate coated with a CPS coating or a protective layer consisting of or consisting essentially of the CPS material. The function(s) of the protective layer may be any one or more of the functions of a protective layer of the present disclosure discussed above. An optional porous dielectric separator 1814 may be provided to electrically separate the cathode 1804 and anode 1808 from one another while allowing ions within an electrolyte 1816 to flow therethrough. The porous dielectric separator 1814 may be made of any one or more suitable materials, for example, any conventional separator materials, such as, but not limited to a polyolefin, a polyolefin blend, a ceramic coated polyolefin or polyolefin blend, to name just a few nonlimiting examples that those of ordinary skill in the art will know. The protective layer 1812, the porous dielectric separator 1814 (if provided), and/or one, the other, or both of the cathode 1804 and the anode 1808, depending on whether porous (e.g., of the intercalating type) or not, may be impregnated at least partially with the electrolyte 1816. The electrochemical device 1800 includes a sealed container 1820 that contains at least the cathode 1804, the anode 1808, the protective layer 1812, the porous dielectric separator 1814 (if provided), and the electrolyte 1816. As those skilled in the art will readily appreciate, the container 1820 may be any suitable type of container, such as a pouch-type container, a cylindrical-type container, or a button-cell-type container, among others, and made of any suitable type(s) of material(s). Those skilled in the art will readily understand the type that the container 1820 may be and the material(s) that the container made be made of suitable for any particular instantiation of the electrochemical device 1800, as there are many well-known container types and materials of construction used for such container types.

As those skilled in the art will understand, depending upon the type and design of the electrochemical device 1800, each of the cathode 1804 and the anode 1808 comprises one or more suitable materials compatible with the salt ions and other constituents of the electrolyte 1816. In some embodiments, the anode 1808 may be an active-metal anode that functions by plating/stripping of an active metal (e.g., lithium, lithium alloy, sodium, sodium alloy, or other alkaline earth metal or alkaline earth metal alloy) during charging/discharging. In some embodiments, the anode 1808 may be, for example, of the intercalating/de-intercalating type, with the active material being any suitable anode active material, such as, but not limited to, natural graphite, artificial graphite, activated carbon, carbon black, conductive additives, lithium titanate, surface-functionalized silicon, and high-performance powdered graphene, among others. The cathode 1804 may comprise any suitable cathode active material, such as, but not limited to, a multi-metal oxide that contains cobalt, nickel, and/or manganese, a metal fluoride, and a lithium metal phosphate, among others. Each of the current collectors 1804CC and 1808CC may be made of any suitable electrically conducting material, such as copper or aluminum, among others. Many battery and supercapacitor constructions that can be used for constructing the electrochemical device of FIG. 18 are known in the art, such that it is not necessary to describe them in any detail for those skilled in the art to understand how to make and use the various aspects of the present disclosure to their fullest scope.

As those skilled in the art will readily appreciate, the presence of the protective layer 1812, which is made in accordance with this disclosure, provides novelty to the electrochemical device 1800. As noted above, the protective layer 1812 may be any construction and any formulation disclosed herein by way of explicit example, method of formulation, and/or underlying fundamental principle(s).

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this disclosure.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

1. An electrochemical cell, comprising:
an anode comprising an active metal that is prone to dendrite growth during charging of the electrochemical cell;
an anode-protective layer disposed immediately adjacent to the anode and provided to inhibit growth of dendrites from the anode, the anode-protective layer comprising a coating that includes:
a polymer system comprising two or more polymers, wherein at least one first polymer of the polymers contains fluorine and at least one second polymer of the polymers contains nitrogen;
one or more active-metal salts dispersed within the polymer system; and
ceramic oxide particles dispersed within the polymer system.

2. The electrochemical cell of claim 1, wherein the active metal comprises an alkaline earth metal.

3. The electrochemical cell of claim 2, wherein the active metal comprises lithium.

4. The electrochemical cell of claim 1, wherein the anode is a lithium-metal anode.

5. The electrochemical cell of claim 1, wherein the anode-protective layer further comprises a substrate, wherein the coating is applied to the substrate and is located so as to confront the anode.

6. The electrochemical cell of claim 5, further comprising a liquid electrolyte, wherein both of the separator and the coating are porous to the liquid electrolyte.

7. The electrochemical cell of claim 5, wherein the anode-protective layer has been heat-laminated to the anode.

8. The electrochemical cell of claim 1, wherein the coating has been applied directly to the anode as a slurry that has been dried.

9. The electrochemical cell of claim 1, wherein the anode comprises lithium, and the ceramic oxide particles are composed of a ceramic oxide that contains lithium.

10. The electrochemical cell of claim 1, wherein the first polymer is selected from the group consisting of poly(vinylidene fluoride-co-hexafluoropropylene), polyvinylidene fluoride, polytetrafluoroethylene, polychlorotrifluoroethylene, fluorinated ethylene-propylene, and polyethylene oxide.

11. The electrochemical cell of claim 10, wherein the second polymer is selected from the group consisting of polyacrylonitrile, poly(styrene-co-acrylonitrile), poly(acrylonitrile-co-butadiene-co-styrene), polymethyl methacrylate, polydimethylsiloxane, and poly(methacrylonitrile).

12. The electrochemical cell of claim 1, wherein the second polymer is selected from the group consisting of polyacrylonitrile, poly(styrene-co-acrylonitrile), poly(acrylonitrile-co-butadiene-co-styrene), polymethyl methacrylate, polydimethylsiloxane, and poly(methacrylonitrile).

13. The electrochemical cell of claim 1, wherein the first polymer comprises poly(vinylidene fluoride-co-hexafluoropropylene) and the second polymer comprises polyacrylonitrile.

14. The electrochemical cell of claim 13, wherein the anode comprises lithium and the one or more active-metal salts includes a lithium salt.

15. The electrochemical cell of claim 14, wherein the ceramic oxide particles comprise lithium.

16. The electrochemical cell of claim 15, wherein the ceramic oxide particles comprise lithium lanthanum zirconium oxide particles.

17. A protective layer for protecting lithium metal within an electrochemical cell, the protective layer comprising:
a coating that includes:
a polymer system comprising two or more polymers, wherein at least one first polymer of the polymers contains fluorine and at least one second polymer of the polymers contains nitrogen;
one or more lithium salts dispersed within the polymer system; and
ceramic oxide particles dispersed within the polymer system.

18. The protective layer of claim 17, further comprising a porous substrate, wherein the coating is applied to the porous substrate.

19. The protective layer of claim 18, wherein both of the porous separator and the coating are porous to the liquid electrolyte.

20. The protective layer of claim 17, wherein the ceramic oxide particles are composed of a ceramic oxide that contains lithium.

21. The protective layer of claim 17, wherein the first polymer is selected from the group consisting of poly(vinylidene fluoride-co-hexafluoropropylene), polyvinylidene fluoride, polytetrafluoroethylene, polychlorotrifluoroethylene, fluorinated ethylene-propylene, and polyethylene oxide.

22. The protective layer of claim 21, wherein the second polymer is selected from the group consisting of polyacrylonitrile, poly(styrene-co-acrylonitrile), poly(acrylonitrile-co-butadiene-co-styrene), polymethyl methacrylate, polydimethylsiloxane, and poly(methacrylonitrile).

23. The protective layer of claim 17, wherein the second polymer is selected from the group consisting of polyacrylonitrile, poly(styrene-co-acrylonitrile), poly(acrylonitrile-co-butadiene-co-styrene), polymethyl methacrylate, polydimethylsiloxane, and poly(methacrylonitrile).

24. The protective layer of claim 17, wherein the first polymer comprises poly(vinylidene fluoride-co-hexafluoropropylene) and the second polymer comprises polyacrylonitrile.

25. The protective layer of claim 17, wherein the ceramic oxide particles comprise lithium lanthanum zirconium oxide particles.

26. (canceled)

27. (canceled)

28. (canceled)

29. (canceled)

30. A method of protecting a lithium-metal anode, the method comprising:
providing a protective layer comprising a coating that includes:
a polymer system comprising two or more polymers, wherein at least one first polymer of the polymers contains fluorine and at least one second polymer of the polymers contains nitrogen;
one or more lithium salts dispersed within the polymer system; and
ceramic oxide particles dispersed within the polymer system; and
deploying the coating so as to contact the lithium-metal anode.

31. The method of claim 30, wherein providing the protective layer includes providing a protective layer that comprises a porous substrate having a side coated with the coating.

32. The method of claim 31, wherein deploying the coating includes contacting the protective layer with the lithium-metal anode so that the coating contacts the lithium-metal anode.

33. The method of claim 32, wherein deploying the coating further includes heat-laminating the protective layer to the lithium-metal anode.

34. The method of claim 30, wherein the coating is formed from a precursor slurry, and deploying the coating further includes:
coating a precursor slurry directly onto the lithium-metal anode; and
drying the precursor slurry coated on the lithium-metal anode so as to form the coating.
